(19) United States
(12) Patent Application Publication
(10) Pub. No.: US 2007/0278100 A1
(43) Pub. Date: Dec. 6, 2007

(54) Apparatus for controlling flow rate in micro-flow path, microchip apparatus comprising flow-rate-controlling apparatus, and flow-rate-controlling method

(75) Inventors: Pu Qian, Saitama-ken (JP); Kazuhiro Kagawa, Saitama-ken (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/807,871

(22) Filed: May 30, 2007

(30) Foreign Application Priority Data
May 30, 2006 (JP) 2006-150579

(51) Int. Cl. G01N 27/00

(52) U.S. Cl. 204/601

(57) ABSTRACT

An apparatus for controlling the flow rate of a fluid passing through a micro-flow path, comprising an electrode layer, an electrolyte layer and a conductive polymer membrane in this order, the conductive polymer membrane being exposed to the micro-flow path, and the flow rate being controlled by supplying electric current from the electrode layer to the conductive polymer membrane via the electrolyte layer.

### FIELD OF THE INVENTION

The present invention relates to a flow-rate-controlling apparatus comprising a conductive polymer membrane exposed to a micro-flow path, which can flexibly change the flow rate of a fluid passing through the micro-flow path, a microchip apparatus comprising such a flow-rate-controlling apparatus, and a flow-rate-controlling method.

### BACKGROUND OF THE INVENTION

To increase efficiency in the synthesis and analysis of chemical substance, development has been conducted vigorously to provide microchips on which systems for synthesis and analysis are integrated. The microchip comprises a substrate of several millimeters to several centimeters in size, and micro-flow paths of ten micrometers to several hundreds of micrometers formed on the substrate. Using this microchip, the synthesis and analysis of chemical substance can be conducted in a reaction liquid of several microliters or less.

A microchip would be remarkably useful, if water and oils contained in a sample were separated simply by passing through micro-flow paths in the analysis of chemical substance. In the case of the synthesis of chemical substance, too, impurities would be able to be removed from a reaction system by separating moisture contained in a solution. If part of pluralities of micro-flow paths provided in the microchip were made hydrophobic, with the remainder made hydrophilic, a microchip would be able to separate oils from water.

JP2005-345279 A discloses a microchip having a two-pronged micro-flow path, one branched micro-flow path being covered with a hydrophobic, diamond-like carbon film, to which fluorine, aluminum or silicon is added, and the other branched micro-flow path being covered with a hydrophilic, diamond-like carbon film, to which nitrogen is added. When a solution containing water and an oil flows through this microchip, moisture passes through the micro-flow path covered with the hydrophilic, diamond-like carbon film, while the oil passes through the micro-flow path covered with the hydrophobic, diamond-like carbon film, resulting in the separation of water from the oil. However, the micro-flow path covered with the diamond-like carbon film is always hydrophobic or hydrophilic. Accordingly, the ratio a hydrophobic flow path to a hydrophilic flow path can neither be changed depending on a water/oil ratio of a sample, nor a particular flow path can be turned hydrophobic or hydrophilic, resulting in poor usability in various applications.

### OBJECTS OF THE INVENTION

Accordingly, an object of the present invention is to provide a flow-rate-controlling apparatus capable of flexibly changing the flow rate of a fluid passing through a micro-flow path.

Another object of the present invention is to provide a microchip apparatus comprising such a flow-rate-controlling apparatus.

A further object of the present invention is to provide a method for controlling the flow rate of a fluid passing through a micro-flow path.

### DISCLOSURE OF THE INVENTION

As a result of intense research in view of the above objects, the inventors have found that when electric current is supplied to a conductive polymer membrane exposed to a micro-flow path, the oxidation/reduction state of the conductive polymer membrane changes, resulting in changing the hydrophilicity and hydrophobicity of the micro-flow path, and thus enabling the control of the flow rate. The present invention has been completed based on such finding.

Thus, the apparatus of the present invention for controlling the flow rate of a fluid passing through a micro-flow path comprises an electrode layer, an electrolyte layer and a conductive polymer membrane in this order, the conductive polymer membrane being exposed to the micro-flow path, and the flow rate being controlled by supplying electric current from the electrode layer to the conductive polymer membrane via the electrolyte layer.

It is preferable that ions move between the electrolyte layer and the conductive polymer membrane when electric current is supplied from the electrode layer. The flow rate is preferably controlled by changing the hydrophilicity and hydrophobicity of the conductive polymer membrane. The conductive polymer membrane is preferably a polypyrrole film.

The microchip apparatus of the present invention comprising the above flow-rate-controlling apparatus, a syringe connected to the micro-flow path, and a linear actuator comprising a conductive polymer powder compact and connected to a piston of the syringe, the linear actuator being driven to move the piston when electric current is supplied to the powder compact.

The method of the present invention for controlling the flow rate of a fluid passing through a micro-flow path formed in a substrate, the micro-flow path comprising an electrode layer, an electrolyte layer and a conductive polymer membrane in this order, comprises supplying electric current from the electrode layer to the conductive polymer membrane via the electrolyte layer to change the hydrophilicity and hydrophobicity of the conductive polymer membrane, thereby controlling the flow rate of the fluid passing through the micro-flow path.

### BRIEF DESCRIPTION OF THE DRAWINGS

FIG. 1 is a plan view showing one example of a microchip, to which the flow-rate-controlling apparatus of the present invention is mounted.

FIG. 2 is a perspective view showing a portion A in FIG. 1.

FIG. 3 is a cross-sectional view taken along the line X-X in FIG. 1.

FIG. 4 is an exploded view showing the flow-rate-controlling apparatus shown in FIGS. 1-3.

FIG. 5(a) is a schematic view showing that one example of the conductive polymer membranes is hydrophilic in an oxidized state.

FIG. 5(b) is a schematic view showing that one example of the conductive polymer membranes is hydrophobic in a neutral or reduced state.

FIG. 5(c) is a schematic view showing that one example of the conductive polymer membranes is returned to be hydrophilic when it is turned to an oxidized state again.

FIG. 6(a) is a schematic view showing that another example of the conductive polymer membranes is hydrophobic in an oxidized state.

FIG. 6(b) is a schematic view showing that another example of the conductive polymer membranes is hydrophilic in a neutral or reduced state.

FIG. 7 is a partially broken plan view showing one example of microchip apparatuses comprising a fluid-supplying means.

FIG. 8(a) is a partially broken plan view showing the operation of the fluid-supplying means, in which a fluid is supplied to the microchip with the linear actuator laminate expanded.

FIG. 8(b) is a partially broken plan view showing the operation of the fluid-supplying means, in which a fluid is introduced into a syringe with the laminate shrunken.

FIG. 9 is a partially broken plan view showing a further example of the microchip apparatus comprising a fluid-supplying means.

### DESCRIPTION OF THE PREFERRED EMBODIMENTS

[1] Microchip

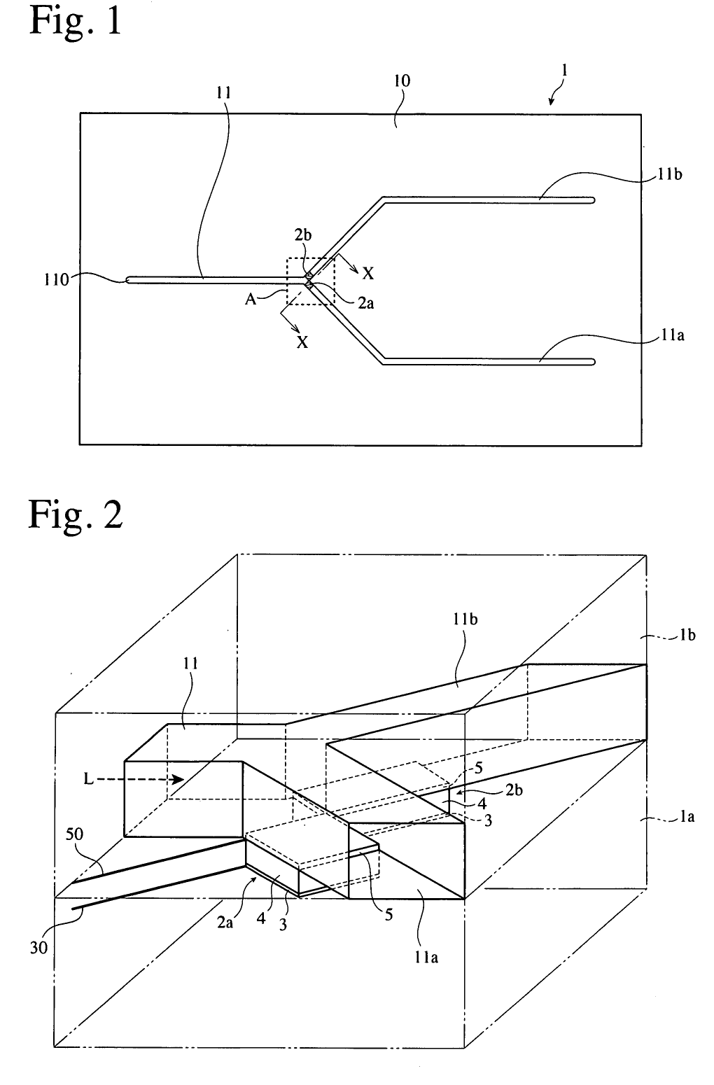

FIG. 1 shows one example of the microchip comprising the flow-rate-controlling apparatus of the present invention. The micro-flow path 11 formed in a substrate 10 of the microchip 1 is branched to first and second flow paths 11a, 11b. The substrate 10 is generally made of silicon, resins, glass, quartz, ceramics, sapphire, etc. A material preferred for the substrate from the aspect of solvent resistance and heat resistance is heat-resistant glass such as Pyrex (registered trademark), etc. Because a glass substrate has high transparency, it is particularly preferable for the microchip 1 for spectroscopic analysis.

The micro-flow path 11 is formed in the substrate 10 by a photoresist method using a photomask, a dry-etching method, a wet-etching method, a mold-pressing method, an injection-molding method, a laser-machining method, a beam-machining method, etc. The width of the micro-flow path 11 may be in a usual range, but it is preferably 1-600 μm, more preferably 10-300 μm. The depth (or height) of the micro-flow path 11 may also be in a usual range, but it is preferably 0.1-2000 μm, more preferably 10-500 μm, from the aspect of ease of controlling the flow rate. Each of the first and second flow paths 11a, 11b is equipped with a flow-rate-controlling apparatus 2a, 2b in contact with the branching point of the micro-flow path 11.

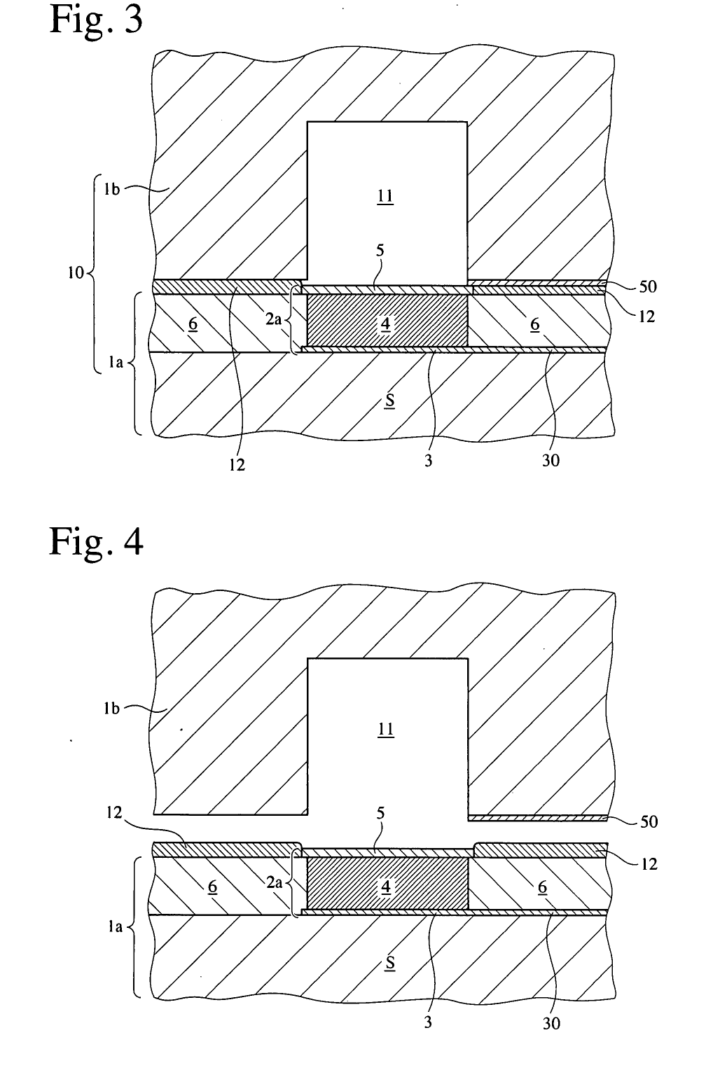

FIG. 2 is a perspective view showing a portion A in FIG. 1, and FIG. 3 is a cross-sectional view taken along the line X-X in FIG. 1. As shown in FIGS. 2 and 3, the microchip 1 is constituted by a substantially planar first substrate 1a equipped with flow-rate-controlling apparatuses 2a, 2b, and a second substrate 1b having grooves on a lower surface, which is bonded to the first substrate 1a. Each of the flow-rate-controlling apparatuses 2a, 2b comprises an electrode layer 3, an electrolyte layer 4 and a conductive polymer membrane 5 in this order on a base substrate S. A sealing layer 12 made of silicone rubber, etc. may be formed on a mating surface of one of the first and second substrates 1a, 1b, if necessary, to secure the sealing of the micro-flow path 11.

The electrode layer 3 may be made of usual electrode materials such as platinum, gold, silver, copper, nickel, carbon, etc. A conductor wire is connected to the electrode layer 3. The electrolyte layer 4 is in a gel form, such that it can supply ions to the conductive polymer membrane 5 while keeping its shape. The electrolyte layer 4 is preferably as thick as 0.1-2000 μm. When the thickness of the electrolyte layer 4 is less than 0.1 μm, short-circuiting easily occurs between the electrode layer 3 and the conductive polymer membrane 5. Even if the thickness of the electrolyte layer 4 were more than 2000 μm, a flow-rate-controlling function would not be improved, only resulting in thick flow-rate-controlling apparatuses 2a, 2b. Preferred examples of the electrolyte layer 4 include polyacrylamide and/or polyethylene glycol in which a salt is dispersed, a gel of a salt-containing agar solution, etc. Examples of the salt contained in the electrolyte layer 4 include sodium chloride, NaPF₆, sodium p-toluene sulfonate and sodium perchlorate.

The conductive polymer membrane 5 is exposed to the micro-flow path 11, so that it comes into contact with a fluid L passing through the micro-flow path 11. Because the conductive polymer membrane 5 is connected to a conductor wire 50, electric current can pass between the conductive polymer membrane 5 and the electrode layer 3. The conductive polymer membrane 5 is preferably as thick as 0.1-2000 μm. The conductive polymer membrane 5 thinner than 0.1 μm is too difficult to form. The conductive polymer membrane 5 thicker than 2000 μm is too slowly turned hydrophobic or hydrophilic when electric current is supplied from the electrode layer 3. Conductive polymers forming the conductive polymer membrane 5 preferably have a conjugated structure. Specifically, they are preferably polypyrrole, polythiophene, polyaniline, polyacetylene and their derivatives, more preferably polypyrrole and their derivatives.

The conductive polymer membrane 5 preferably contains a dopant, which may be a p-type or an n-type, and usual dopants may be used. The p-type dopants include halogens (for instance, Cl₂, Br₂, I₂, ICl, ICl₃, IBr and IF₃), Lewis acids (for instance, PF₅, PF₆, BF₄, AsF₅ and SbF₅), sulfuric acid, nitric acid, perchloric acid, organic acids (for instance, p-toluene sulfonic acid), and transition metal salts (for instance, iron trichloride, titanium tetrachloride, iron sulfate, iron nitrate, iron perchlorate, iron phosphate, iron sulfonate, iron bromide, iron hydroxide, copper nitrate, copper sulfate and copper chloride). The n-type dopants include alkali metals (for instance, Li, Na, K, Rb and Cs), alkaline earth metals (for instance, Be, Mg, Ca, Sc and Ba), Ag, Eu and Yb. The dopant-containing conductive polymer membrane 5 may be produced by a method (electrolytic polymerization method) comprising immersing an anode and a cathode in an electrolytic solution containing a monomer and a dopant, and supplying electric current between both electrodes.

Taking for example a case where the conductive polymer membrane 5 is a polypyrrole film containing p-toluene sulfonic acid as a dopant, and the electrolyte layer 4 is agar containing sodium chloride, the change of the conductive polymer membrane 5 caused by electric current will be explained.

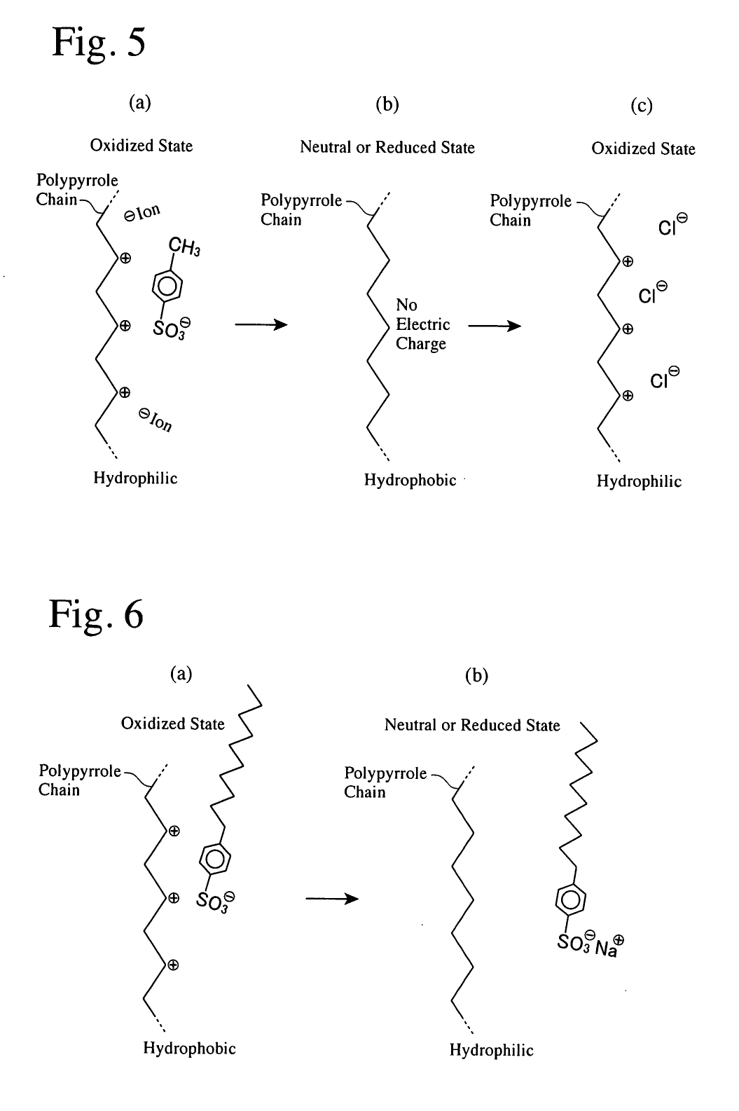

As shown in FIG. 5(a), a polypyrrole chain has positive charge when the conductive polymer membrane 5 is in an oxidized state, so that p-toluene sulfonic acid and other negative ions get close to the polypyrrole chain to have electrical neutrality. The existence of this electric charge makes the conductive polymer membrane 5 hydrophilic. When this conductive polymer membrane 5 is turned neutral by electric current, electric charge disappears from the polypyrrole chains, as shown in FIG. 5(b), so that the conductive polymer membrane 5 is turned hydrophobic. Further reduction of the conductive polymer membrane 5 does not substantially change the state of ions around the polypyrrole chains, leaving the conductive polymer membrane 5 to be hydrophobic. When the conductive polymer membrane 5 is turned to an oxidized state again, the polypyrrole chains are provided with positive charge again, so that chloride ions are supplied from the electrolyte layer 4 [FIG. 5(c)]. As a result, the conductive polymer membrane 5 is turned hydrophilic. Namely, the conductive polymer membrane 5 is made hydrophobic when it is turned to a neutral or reduced state by electric current, while it is made hydrophilic when it is turned to an oxidized state.

When the conductive polymer membrane 5 exposed to the micro-flow path 11 is turned to an oxidized state, a hydrophilic fluid can pass through the micro-flow path 11, while a hydrophobic fluid cannot pass through the micro-flow path 11 unless the hydrophobic fluid is at a pressure exceeding the surface tension resistance of the conductive polymer membrane 5. The term “hydrophilic fluid” used herein means a solution or dispersion containing water, or a solution or dispersion containing an organic solvent sufficiently miscible with water. Organic solvents miscible with water include methanol, ethanol, formic acid, acetic acid, formaldehyde, acetaldehyde, acetone, etc., which preferably has about 1-3 carbon atoms. The term “hydrophobic fluid” means a solution or dispersion containing a solvent that is substantially not miscible with water. The hydrophobic fluid is preferably an organic solvent having about 4 or more carbon atoms. When the conductive polymer membrane 5 is turned to an oxidized state, the conductive polymer membrane 5 acts as a closed valve to a hydrophobic fluid flowing through the micro-flow path 11 at a pressure equal to or lower than the surface tension resistance. A hydrophobic fluid at a pressure exceeding the surface tension resistance passes through the micro-flow path 11, while the conductive polymer membrane 5 turned to an oxidized state in proportion to the applied voltage acts as a resistance for the hydrophilic fluid to pass. Accordingly, the flow rate of the hydrophobic fluid can be controlled by turning the conductive polymer membrane 5 hydrophilic or hydrophobic by the applied voltage.

When the conductive polymer membrane 5 exposed to the micro-flow path 11 is turned to a neutral or reduced state, a hydrophobic fluid can pass through the micro-flow path 11, while a hydrophilic fluid cannot pass through the micro-flow path 11 unless the hydrophilic fluid has a pressure exceeding the surface tension resistance. Accordingly, the conductive polymer membrane 5 set in a neutral or reduced state acts as a closed valve to a hydrophilic fluid at a pressure equal to or lower than the surface tension resistance. A hydrophilic fluid at a pressure exceeding the surface tension resistance passes through the micro-flow path 11, while the conductive polymer membrane 5 turned to a reduced state in proportion to the applied voltage acts as a resistance to the flowing of the hydrophilic fluid. Accordingly, the flow rate of the hydrophilic fluid can be controlled by turning the conductive polymer membrane 5 hydrophilic or hydrophobic by the applied voltage.

When a hydrophilic fluid and a hydrophobic fluid contained in a sample are separated by the microchip 1 shown in FIG. 1, a mixture of a hydrophilic fluid and a hydrophobic fluid is introduced into the micro-flow path 11 through an inlet 110, for instance, with a conductive polymer membrane 5 in the first flow-rate-controlling apparatus 2a turned hydrophilic by oxidation, and with a conductive polymer membrane 5 in the second flow-rate-controlling apparatus 2b turned hydrophobic by reduction. To oxidize the conductive polymer membrane 5, electric current is supplied, such that the conductive polymer membrane 5 is turned to an anode, and that the electrode layer 3 is turned to a cathode. To reduce the conductive polymer membrane 5, opposite electric current is supplied. While hydrophilic fluid components contained in the sample pass through the first flow path 11a but not through the second flow path 11b, hydrophobic fluid components pass through the second flow path 11b but not through the first flow path 11a. As a result, the hydrophilic fluid and the hydrophobic fluid are separated. Of course, if electric current in an opposite direction to that described above were supplied to the first and second flow-rate-controlling apparatuses 2a, 2b, opposite components to those described above would pass through the first and second flow paths 11a, 11b.

When the conductive polymer membrane 5 is turned to a neutral or reduced state, the conductive polymer membrane 5 may be made hydrophilic in some cases. When a dopant contained in the conductive polymer membrane 5 is an organic acid having a long hydrophobic group, the long hydrophobic group of the dopant exists near polypyrrole chains provided with positive charge, as shown in FIG. 6(a). Thus, this conductive polymer membrane 5 is hydrophobic in an oxidized state. When the conductive polymer membrane 5 is turned to a neutral or reduced state, the organic acid having a long hydrophobic group becomes distant from the polypyrrole chains, thereby being neutralized by sodium ions supplied from the electrolyte layer 4 [FIG. 6(b)]. Since the ionic action of the dopant is dominant because of no electric charge in the polypyrrole chains, this conductive polymer membrane 5 is hydrophilic in a neutral or reduced state.

Because the oxidation/reduction state of the conductive polymer membrane 5 continuously changes depending on the applied voltage, the degree of hydrophilicity or hydrophobicity also continuously changes. Accordingly, the level of hydrophilicity or hydrophobicity of the conductive polymer membrane 5 can be changed by the applied voltage to control the flow rate of a sample flowing through the micro-flow path 11.

[2] Production of Microchip

One example of methods for producing the microchip 1 shown in FIGS. 1-4 will be explained. First, the electrode layer 3 and the conductor wire 30 are formed on the base substrate S, for instance, by a method of vapor-depositing a metal on the masked base substrate S. The entire surface of the base substrate S is covered with a resin such as a photoresist to form an insulating layer 6, and the insulating layer 6 on the electrode layer 3 is etched. After holes formed by etching are filled with an electrolyte solution, the electrolyte solution is turned to sol or gel to form the electrolyte layer 4. The electrolyte layer 4 is then covered with a conductive polymer membrane 5 produced by electrolytic polymerization, to obtain a first substrate 1a. Because an electrolyte is dissolved into a fluid L when the electrolyte layer 4 comes into contact with the fluid L, the electrolyte layer 4 is covered with the conductive polymer membrane 5, such that the electrolyte layer 4 is not exposed to the micro-flow path 11.

The second substrate 1b is etched to form the micro-flow path 11 and provided with a conductor wire 50 for the conductive polymer membrane 5 by a vapor deposition method, etc. As shown in FIG. 4, the first substrate 1a is assembled to the second substrate 1b such that the micro-flow path 11 is opposite to the conductive polymer membrane 5, resulting in the conductor wire 50 in contact with the conductive polymer membrane 5. The first substrate 1a may be pressure-bonded to the second substrate 1b.

[3] Microchip Apparatus

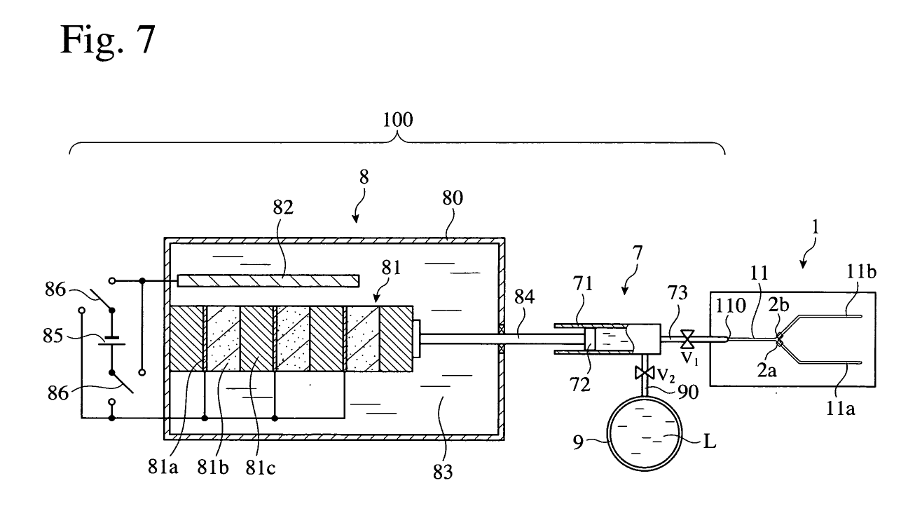

FIG. 7 shows one example of the microchip apparatuses of the present invention. This microchip apparatus comprising a microchip 1, a fluid-supplying means 100 connected to an inlet 110 of the microchip 1, and flow-rate-controlling apparatuses 2a, 2b provided in the micro-flow path 11 of the microchip 1. Because the microchip 1 shown in FIG. 7 and the flow-rate-controlling apparatuses 2a, 2b mounted to the microchip 1 are the same as shown in FIGS. 1-4, the fluid-supplying means 100, an only difference, will be explained below.

The fluid-supplying means 100 comprises a syringe 7 comprising a cylinder 71 and a piston 72 slidable therein, a linear actuator 8 for driving the piston 72, and a reservoir 9 of a fluid L connected to the syringe 7. The movement of the piston 72 causes the fluid L to enter into or exit from the cylinder 71. The cylinder 71 is connected to the microchip 1 via a pipe 73, and to the reservoir 9 via a pipe 90, so that the fluid L supplied from the reservoir 9 to the syringe 7 through the pipe 90 enters into the microchip 1 through the pipe 73. The pipes 73, 90 are provided with first and second valves V₁, V₂.

The linear actuator 8 comprises a cell 80, a laminate 81 contained in the cell 80 and extendable in a longitudinal direction of the cell 80, a counter electrode 82 in parallel with the laminate 81 in the cell 80, and an ion donor 83 filling the cell 80. The laminate 81 is constituted by alternately laminating and bonding conductive powder compacts 81b and porous spacers 81c via working electrodes 81a. The laminate 81 has one end bonded to the cell 80, and the other end connected to the driving rod 84 of the piston 72 in the syringe 7. The shrinkage and expansion of the laminate 81 moves the driving rod 84 to cause the piston 72 to slide in the cylinder 71.

The preferred thickness of each powder compact 81b is 0.1-20 mm. When the thickness is less than 0.1 mm, the powder compact 81b is too easily broken in handling. When the thickness of the powder compact 81b is more than 20 mm, the absorption and desorption of ions, etc. into and from the ion donor 83 are too slow, resulting in the powder compact 81b with poor response.

To produce the powder compact 81b, for instance, the conductive powder is charged into a tablet mold, evacuated in the tablet mold, and compressed at 700-900 MPa for about 3-10 minutes. The conductive powder preferably has electric resistance of 10⁻⁴ Ω to 1 MΩ. The electric resistance of the conductive powder is measured by a four-terminal method with an electrode gap of 1.5 mm. When the electric resistance is more than 1 MΩ, the conductivity of the conductive powder is too low to provide an efficient linear actuator. The conductive powder having electric resistance of less than 10⁻⁴ Ω is difficult to produce.

The conductive powder comprises a conductive polymer and a dopant. Preferred examples of the conductive polymer and the dopant are the same as in the above conductive polymer membrane 5. In addition to the conductive polymer and the dopant, the conductive powder preferably contains metals (for instance, iron, copper, nickel, titanium, zinc, chromium, aluminum, cobalt, gold, platinum, silver, manganese, tungsten, palladium, ruthenium and zirconium), metal salts (for instance, iron trichloride and copper chloride), carbon, etc. The details of the preferred conductive powder and its production methods are described in JP2005-124293 A.

The working electrode 81a may be adhered to the powder compact 81b, or may be formed on the powder compact 11 by chemical plating, electric plating, vapor deposition, etc. Three working electrodes 81a and a counter electrode 82 are connected to a power supply 85. Disposed on both sides of the power supply 85 are switches 86, 86 for switching the direction of electric current supplied to the working electrodes 81a and the counter electrode 82.

The ion donor 83 containing ions to be supplied to the conductive powder has conductivity. A solvent and/or a dispersant contained in the ion donor 83 are preferably water, polar organic solvents or ionic liquids, such that the fluid L has high conductivity. When the solvent is water, an aqueous electrolytic solution preferably has a concentration of about 0.01-5 mol/L.

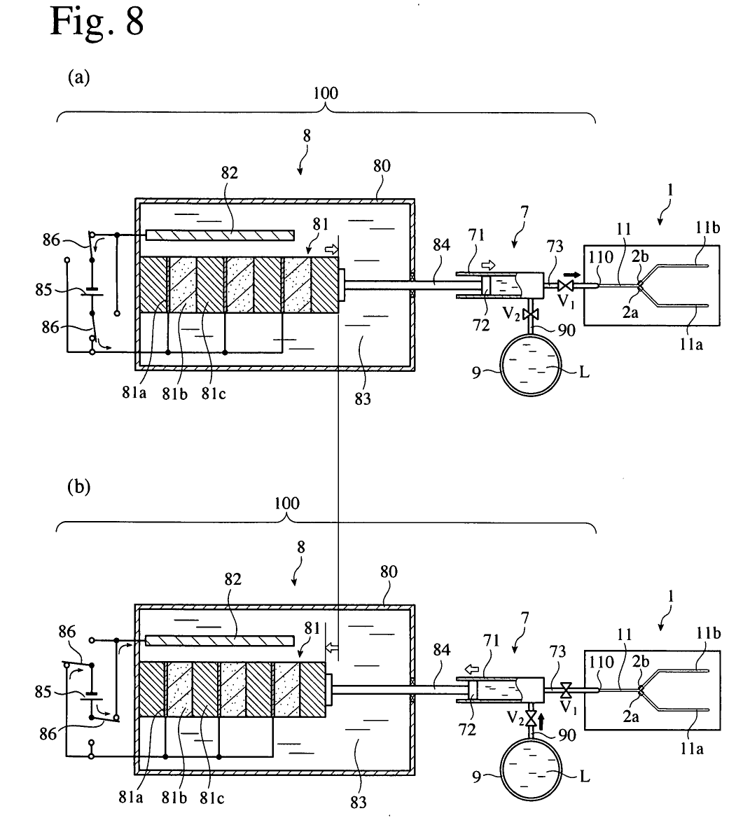

In order that the fluid-supplying means 100 supplies the fluid L to the micro-flow path 11, electric current is supplied between the working electrodes 81a and the counter electrode 82, such that the working electrodes 81a act as anodes while the counter electrode 82 acts as a cathode, with the first valve V₁ opened and the second valve V₂ closed, as shown in FIG. 8(a). The conductive polymer contained in the powder compacts 81b is oxidized, and expanded by absorbing the ion donor 83. Thus, the piston 72 moves toward the microchip 1, so that the fluid L is discharged from the cylinder 71, and enters into the micro-flow path 11 of the microchip 1 through the pipe 73.

To supply the fluid L to the cylinder 71, the first valve V₁ is closed, and the second valve V₂ is opened as shown in FIG. 8(b), and switches 86, 86 are switched to supply electric current to the working electrodes 81a and the counter electrode 82, such that the working electrodes 81a act as cathodes, and the counter electrode 82 acts as an anode. By this current supply, the conductive polymer contained in the powder compacts 81b is reduced, so that the powder compacts 81b shrink by discharging the ion donor 83. Thus, the piston 72 moves toward the linear actuator 8, so that the fluid L enters into the cylinder 71 through the pipe 90.

The moving distance of the piston 72 is equal to the distance of expansion or shrinkage of the laminate 81, which is proportional to the voltage applied between the working electrodes 81a and the counter electrode 82. Accordingly, the amount of the fluid L supplied can be determined by the voltage applied between the working electrodes 81a and the counter electrode 82. The voltage necessary for the expansion and shrinkage of the laminate 81 is substantially 0.1-1.5 V, though it may vary depending on the distance of expansion or shrinkage of the laminate 81 and the electric resistance of the powder compacts 81b and the ion donor 83. The direction of electric current supplied between the working electrodes 81a and the counter electrode 82 to extend the laminate 81 by expanding the powder compacts 81b is determined by the types of the conductive polymer and the ion donor 83.

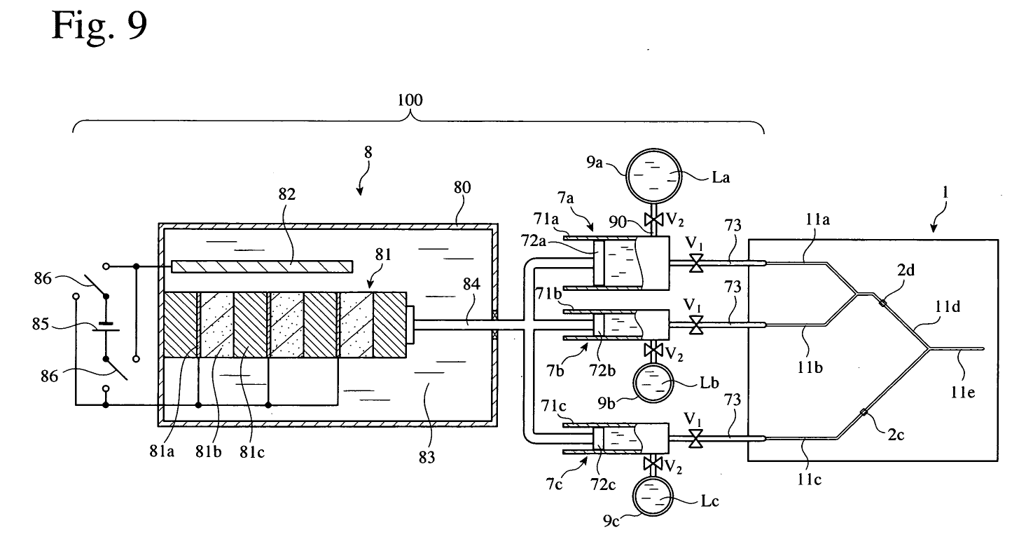

FIG. 9 shows another example of the microchip apparatuses of the present invention. Because this microchip apparatus is substantially the same as that shown in FIGS. 7 and 8 except for comprising three syringes 7a, 7b, 7c each supplying a fluid La, Lb, Lc to a micro-flow path 11a, 11b, 11c, only differences will be explained below.

The microchip 1 comprises on the inlet side three micro-flow paths 11a, 11b, 11c, which successively converge to one flow path. The micro-flow path 11a first converges with the micro-flow path 11b to provide a converged flow path 11d, which then converges with the micro-flow path 11c to provide a converged flow path 11e. In this microchip 1, different fluids La, Lb, Lc can be supplied to the micro-flow paths 11a, 11b, 11c, and successively converged. This microchip 1 is thus suitable for synthesis in which three types of chemical species a, b, c are successively reacted. The micro-flow path 11c and the converged flow path 11d are respectively equipped with flow-rate-controlling apparatuses 2c, 2d.

Connected to the cylinders 71a, 71b, 71c are reservoirs 9a, 9b, 9c each containing a fluid La, Lb, Lc. Because pistons 72a, 72b, 72c are fixed to tip ends of a three-pronged, driving rod 84 connected to a laminate 81, the pistons 72a, 72b, 72c are moved by the driving rod 84 by the distance of expansion or shrinkage of the laminate 81. Accordingly, the volume proportions of the fluids La, Lb, Lc supplied to the micro-flow paths 11a, 11b, 11c are determined by the cross section areas of the cylinders 71a, 71b, 71c.

With the first valve V₁ opened and the second valve V₂ closed in each syringe 7a, 7b, 7c, the powder compacts 81b in the laminate 81 are oxidized by supplying electric current, such that the laminate 81 is extended. Because the driving rod 84 moves toward the microchip 1 by the distance of extension of the laminate 81, the pistons 72a, 72b, 72c also move by the same distance, so that the fluids La, Lb, Lc contained in the cylinders 71a, 71b, 71c are pushed by the pistons 72a, 72b, 72c to enter into the micro-flow paths 11a, 11b, 11c.

The fluid La entering into the micro-flow path 11a first converges with the fluid 11b, so that the chemical species a and the chemical species b contained therein are reacted in the converged flow path 11d. When electric current is supplied to a flow-rate-controlling apparatus 2d provided in the converged flow path 11d, the oxidation/reduction state of the conductive polymer membrane 5 in the flow-rate-controlling apparatus 2d is changed, resulting in the change of a flow rate in the converged flow path 11d. It is thus possible to control the speeds of both fluids containing chemical species a and b. A fluid containing a chemical species d, a reaction product of the chemical species a and the chemical species b, converges with the fluid Lc containing the chemical species c in the converged flow path 11e. Because a flow-rate-controlling apparatus 2c is mounted to the micro-flow path 11c, the rate of the fluid Lc flowing through the micro-flow path 11c can be controlled so that it is in line with the speed of forming the chemical species d, etc.

With the second valve V₂ opened and the first valve V₁ closed in each syringe 7a, 7b, 7c, electric current is supplied to the powder compacts 81b of the laminate 81. As a result, the laminate 81 shrinks because the powder compacts 81b are reduced, thereby moving the driving rod 84 and the pistons 72a, 72b, 72c fixed thereto toward the laminate 81. The movement of the pistons 72a, 72b, 72c transfers the fluids La, Lb, Lc from the reservoirs 9a, 9b, 9c to the cylinders 71a, 71b, 71c.

The present invention will be explained in more detail referring to Examples below without intentions of restricting the present invention thereto.

### EXAMPLE 1

(a) Production of Conductive Polymer Membrane

A conductive polypyrrole membrane as thick as 20 μm was formed on a working electrode by an electrolytic polymerization method for 20 minutes under the following conditions.

| | |
|---|---|
| Monomer solution: | 0.1 mol/L of pyrrole monomer, |
| | 0.1 mol/L of C₁₀H₂₁—C₆H₄—SO₃Na, and |
| | water as a solvent. |
| Working electrode: | Platinum plate. |
| Counter electrode: | Nickel plate. |
| Reference electrode: | Silver/silver chloride. |
| Voltage: | 0.55 V |

(b) Oxidation/Reduction Reaction of Conductive Polymer Membrane

A platinum electrode (working electrode) provided with the conductive polymer membrane, a platinum electrode (counter electrode), and a silver/silver chloride electrode (reference electrode) were immersed in a 1.0-M aqueous sodium chloride solution. After voltage of 0.8 V was applied between the working electrode and the counter electrode for 1 minute to oxidize the conductive polymer membrane, the conductive polymer membrane was taken out of the aqueous sodium chloride solution. After the conductive polymer membrane was dried, water was dropped onto the conductive polymer membrane. The conductive polymer membrane repulsed water, indicating that it was hydrophobic.

With the same conductive polymer membrane immersed in an aqueous sodium chloride solution, voltage of −0.8 V was applied for 1 minute to reduce the conductive polymer membrane. After the conductive polymer membrane was dried, water was dropped onto the conductive polymer membrane. The conductive polymer membrane adsorbed water, indicating that it was hydrophilic. Repeating the oxidation and reduction of the conductive polymer membrane, the conductive polymer membrane was dried, and water was dropped thereonto. As a result, it was confirmed that the hydrophobization and hydrophilization of the conductive polymer membrane were reproducible.

This conductive polymer membrane was immersed in an aqueous sodium chloride solution again, and voltage of 0 V was applied for 1 minute to turn the conductive polymer membrane neutral. Because the conductive polymer membrane has a self-potential of about 0.2 V, the applied voltage of 0 V means that the conductive polymer membrane was in a state where voltage was applied. The conductive polymer membrane was taken out of the aqueous sodium chloride solution and dried, and water was dropped thereonto. The conductive polymer membrane repulsed water like in a case where it was oxidized, indicating that it was hydrophobic.

### EXAMPLE 2

(a) Production of Conductive Polymer Membrane

A conductive polypyrrole membrane as thick as 50 μm was formed on a working electrode by an electrolytic polymerization method for 20 minutes under the following conditions.

| | |
|---|---|
| Monomer solution: | 0.3 mol/L of pyrrole monomer, |
| | 0.2 mol/L of CH₃—C₆H₄—SO₃Na, and |
| | water as a solvent. |
| Working electrode: | Titanium plate. |
| Counter electrode: | Nickel plate. |
| Reference electrode: | Silver/silver chloride. |
| Voltage: | 0.8 V |

(b) Oxidation/Reduction Reaction of Conductive Polymer Membrane

The conductive polymer membrane formed in the step (a) in Example 2 was oxidized and reduced in the same manner as in the step (b) in Example 1, to examine whether it was hydrophobic or hydrophilic. This conductive polymer membrane was hydrophobic when it was reduced by applying voltage of −0.8 V, and hydrophilic when it was reduced by applying voltage of 0.8 V, opposite to that obtained in step (a) in Example 1.

### EFFECT OF THE INVENTION

Using the flow-rate-controlling apparatus of the present invention, the flow rate of a fluid passing through a micro-flow path can be changed in proportion to voltage applied between the conductive polymer membrane and the electrode layer. The flow-rate-controlling method of the present invention capable of flexibly controlling the flow rate of a fluid passing through a micro-flow path simply by changing voltage applied to the conductive polymer membrane provided in the micro-flow path is usable in extremely wide applications.

What is claimed is:

1. An apparatus for controlling the flow rate of a fluid passing through a micro-flow path, comprising an electrode layer, an electrolyte layer and a conductive polymer membrane in this order, said conductive polymer membrane being exposed to said micro-flow path, and the flow rate being controlled by supplying electric current from said electrode layer to said conductive polymer membrane via said electrolyte layer.

2. The flow-rate-controlling apparatus according to claim 1, wherein ions move between said electrolyte layer and said conductive polymer membrane when electric current is supplied from said electrode layer.

3. The flow-rate-controlling apparatus according to claim 1, wherein the flow rate is controlled by changing the hydrophilicity and hydrophobicity of said conductive polymer membrane.

4. The flow-rate-controlling apparatus according to claim 1, wherein said conductive polymer membrane is a polypyrrole film.

5. A microchip apparatus comprising an apparatus for controlling the flow rate of a fluid passing through a micro-flow path, a syringe connected to said micro-flow path, and a linear actuator comprising a conductive polymer powder compact and connected to a piston of said syringe; the flow-rate-controlling apparatus comprising an electrode layer, an electrolyte layer and a conductive polymer membrane in this order, said conductive polymer membrane being exposed to said micro-flow path, the flow rate being controlled by supplying electric current from said electrode layer to said conductive polymer membrane via said electrolyte layer, and said linear actuator being driven to move said piston when electric current is supplied to said powder compact.

6. A method for controlling the flow rate of a fluid passing through a micro-flow path formed in a substrate, said micro-flow path comprising an electrode layer, an electrolyte layer and a conductive polymer membrane in this order, the method comprising supplying electric current from said electrode layer to said conductive polymer membrane via said electrolyte layer to change the hydrophilicity and hydrophobicity of said conductive polymer membrane, thereby controlling the flow rate of the fluid passing through said micro-flow path.
